(19) United States
(12) Patent Application Publication
(10) Pub. No.: US 2024/0323883 A1
(43) Pub. Date: Sep. 26, 2024

(54) PURPOSE-DEPENDENT DETERMINATION OF START OF RECEIVER SYMBOL PROCESSING WINDOW

(71) Applicant: Telefonaktiebolaget LM Ericsson (publ), Stockholm (SE)

(72) Inventors: Niklas JALDÉN, ENKÖPING (SE); Henrik ASPLUND, STOCKHOLM (SE); Karl WERNER, SEGELTORP (SE); Satyam DWIVEDI, SOLNA (SE)

(73) Assignee: Telefonaktiebolaget LM Ericsson (publ), Stockholm (SE)

(21) Appl. No.: 18/575,273

(22) PCT Filed: Jun. 30, 2021
(86) PCT No.: PCT/SE2021/050652

§ 371 Date: Dec. 28, 2023

(51) Int. Cl. H04W 56/00; H04L 25/02

(52) U.S. Cl. CPC H04W 56/005; H04L 25/0212

(57) ABSTRACT

There is provided mechanisms for purpose-dependent determination of start of a receiver symbol processing window. A method is performed by a wireless transceiver unit. The method comprises receiving, from another wireless transceiver unit, a reference signal based on which the start of the receiver symbol processing window is to be determined. The reference signal is to be processed for a processing purpose selected from a set of at least two different processing purposes. The method comprises determining a synchronization time offset from measurements on the reference signal according to an estimation process that is a function of the processing purpose. The synchronization time offset defines placement of the start of the receiver symbol processing window. According to the estimation process, the start of the receiver symbol processing window is placed differently with respect to the at least two different processing purposes.

### TECHNICAL FIELD

Embodiments presented herein relate to a method, a wireless transceiver unit, a computer program, and a computer program product for purpose-dependent determination of the start of a receiver symbol processing window.

### BACKGROUND

In orthogonal frequency-division multiplexing (OFDM) based communication systems, information symbols are modulated on parallel subcarriers on different frequencies. A practical OFDM modulator converts these subcarriers into a time domain sequence of samples, for example using an inverse Fast Fourier Transform (IFFT). The full sequence of time samples is referred to as one OFDM symbol. To avoid inter-symbol interference (ISI) or inter-carrier interference (ICI) due to time-dispersive channels, a so-called cyclic prefix (CP) is added where the last part (of duration T_{CP}) of the OFDM symbol is copied and added at the beginning of the symbol before transmission. Transmission is block-based, where different OFDM symbols are transmitted sequentially. FIG. 1 schematically illustrates a sequence of OFDM symbols. FIG. 1(a) schematically illustrates a sequence of OFDM symbols, of length T_{S} where ISI occurs due to time dispersion which in turn is caused by multiple communication paths (or just multipaths for short) between transmitter (Tx) and receiver (Rx). FIG. 1(b) schematically illustrates a sequence of OFDM symbols as in FIG. 1 but where ISI is avoided through the addition of a CP to each transmitted symbol followed by the first part of each received symbol corresponding to the CP length at the receiver.

The receiver processes time samples corresponding to each OFDM symbol by first discarding the CP and then performing, for example, a Fast Fourier Transform (FFT), after which the information symbols on each subcarrier can be extracted from the Fourier coefficients. If the CP is long with respect to (or even longer than) the delay spread of the radio propagation channel, and if synchronization works, there will be only small (or even no) ISI or ICI.

The receiver also needs to determine where one OFDM symbol ends and the next starts in order to perform the above block processing on each OFDM symbol separately. This is referred to as synchronization and is in communication systems based on the Long-Term Evolution (LTE) suite of telecommunication standards and the New Radio (NR) suite of telecommunication standards performed with the help of synchronization signals (which are used also to synchronize the subcarrier frequencies between the transmitter and the receiver). The synchronization allows the receiver to align its time window for the FFT to the start of the received OFDM symbol. Hereinafter, this time window is therefore referred to as the receiver symbol processing window.

The signal in the CP contains a repetition of parts of the information-carrying signal and hence represents an overhead. The CP length should therefore not be over-dimensioned. Hence the ISI/ICI suppression is balanced against the overhead. Typically, a robust CP length is used that spans the strong multipath in most cases, but not all multipath in all cases. For the purpose of reducing ISI/ICI (as described above), the CP could be filled by any sequence of samples. In OFDM systems, such as communication systems based on LTE or NR, the CP is filled by a copy of the last samples of the OFDM symbol. This makes the effect of a (time invariant) radio propagation channel on the OFDM symbol behave as a cyclic convolution. This property allows for accurate channel estimation and equalization. As a consequence, the signal received over any tap that falls inside the receiver symbol processing window will be a cyclically shifted version of the transmitted signal (disregarding the scaling with a complex amplitude), with the shift relating to the delay of the tap. However, any tap that falls outside of the receiver symbol processing window will not result in a perfect (scaled) cyclically shifted version of the transmitted signal.

For a non-dispersive radio propagation channel the start of the receiver symbol processing window can be any time between the start and the end of the CP without risk of overlap with the next (or previous) OFDM symbol. However, in a time-dispersive radio propagation channel the margin shrinks according to the amount of delay spread. FIG. 2 schematically illustrates different synchronization positions (as defined by the start of the receiver symbol processing window of length T) can be used without introducing ISI as long as the receiver symbol processing window does not contain any part of the previous symbol (delayed with the time dispersion) or the following symbol. FIGS. 2(a), 2(b) and 2(c) all illustrate examples where the object is to decode the second OFDM symbol. At FIG. 2(a) is illustrated an example where no ISI occurs since the start of the receiver symbol processing window is outside the CP. At FIG. 2(b) is illustrated an example where no ISI occurs since the start of the receiver symbol processing window is within the CP but not where the CP is affected by ISI from the first OFDM symbol. At FIG. 2(c) is illustrated an example where ISI occurs since the start of the receiver symbol processing window is within the CP where the CP is affected by ISI from the first OFDM symbol.

One strategy in the state of the art is to position the start (hereinafter denoted to) of the receiver symbol processing window such that the time-dispersive radio propagation channel is maximally contained in the time interval spanning from t₀ to t₀+T_{CP}, as this minimizes the ISI and ICI and leads to better spectral efficiency through a higher signal to noise ratio (SNR). For a channel impulse response that is symmetrical in time this can be achieved by aligning the receiver symbol processing window such that the mean delay in the channel impulse response occurs in the center of the receiver symbol processing window. Often, there is some a priori knowledge or assumption of the shape of the impulse response that can be utilized, such as the fact the impulse response is non-symmetrical with a roughly exponentially decaying power. Therefore, the strongest peak in the impulse response is commonly positioned closer to the beginning of the receiver symbol processing window than to its end.

However, there could be cases where this strategy (i.e. to position the start t₀ of the receiver symbol processing window such that the time-dispersive radio propagation channel is maximally contained in the time interval spanning from t₀ to t₀+T_{CP}) does not lead to the best placement of the receiver symbol processing window.

Hence, there is still a need for techniques that enable improved placement of the receiver symbol processing window.

### SUMMARY

An object of embodiments herein is to provide techniques for placement of the receiver symbol processing window that address the above issues.

A particular object of embodiments herein is to provide techniques for purpose-dependent determination of the start of the receiver symbol processing window.

According to a first aspect there is presented a method for purpose-dependent determination of the start of the receiver symbol processing window. The method is performed by a wireless transceiver unit. The method comprises receiving, from another wireless transceiver unit, a reference signal based on which the start of the receiver symbol processing window is to be determined. The reference signal is to be processed for a processing purpose selected from a set of at least two different processing purposes. The method comprises determining a synchronization time offset from measurements on the reference signal according to an estimation process that is a function of the processing purpose. The synchronization time offset defines placement of the start of the receiver symbol processing window. According to the estimation process, the start of the receiver symbol processing window is placed differently with respect to the at least two different processing purposes.

According to a second aspect there is presented a wireless transceiver unit for purpose-dependent determination of the start of the receiver symbol processing window. The wireless transceiver unit comprises processing circuitry. The processing circuitry is configured to cause the wireless transceiver unit to receive, from another wireless transceiver unit, a reference signal based on which the start of the receiver symbol processing window is to be determined. The reference signal is to be processed for a processing purpose selected from a set of at least two different processing purposes. The processing circuitry is configured to cause the wireless transceiver unit to determine a synchronization time offset from measurements on the reference signal according to an estimation process that is a function of the processing purpose. The synchronization time offset defines placement of the start of the receiver symbol processing window. According to the estimation process, the start of the receiver symbol processing window is placed differently with respect to the at least two different processing purposes.

According to a third aspect there is presented a wireless transceiver unit for purpose-dependent determination of the start of the receiver symbol processing window. The wireless transceiver unit comprises a receive module configured to receive, from another wireless transceiver unit, a reference signal based on which the start of the receiver symbol processing window is to be determined. The reference signal is to be processed for a processing purpose selected from a set of at least two different processing purposes. The wireless transceiver unit comprises a determine module configured to determine a synchronization time offset from measurements on the reference signal according to an estimation process that is a function of the processing purpose. The synchronization time offset defines placement of the start of the receiver symbol processing window. According to the estimation process, the start of the receiver symbol processing window is placed differently with respect to the at least two different processing purpose.

According to a fourth aspect there is presented a computer program for purpose-dependent determination of the start of a receiver symbol processing window, the computer program comprising computer program code which, when run on a wireless transceiver unit, causes the wireless transceiver unit to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient techniques for placement of the receiver symbol processing window that address the above issues.

Advantageously, these aspects provide techniques for purpose-dependent determination of the start of the receiver symbol processing window.

Advantageously, the proposed purpose-dependent determination of the start of the receiver symbol processing window increases likelihood of correctly detecting the first or early multipath, leading to improved positioning accuracy. Alternatively, the positioning accuracy can be maintained for dispersive channels even if the CP length is short. Advantageously, this is achieved whilst still keeping the accuracy for placement of the receiver symbol processing window for communication.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a sequence of OFDM symbols according to an example;

FIG. 2 schematically illustrates different synchronization positions according to examples;

FIG. 3 is a schematic diagram illustrating a communication system according to embodiments;

FIG. 4 schematically illustrates different channel impulse responses and receiver symbol processing windows according to embodiments;

FIG. 5 is a flowchart of methods according to embodiments;

FIG. 6 schematically illustrates extraction of blocks from a reference signal according to embodiments;

FIG. 7 is a schematic diagram showing functional units of a wireless transceiver unit 200a, 200b according to an embodiment;

FIG. 8 is a schematic diagram showing functional modules of a wireless transceiver unit 200a, 200b according to an embodiment; and

FIG. 9 shows one example of a computer program product comprising computer readable storage medium according to an embodiment.

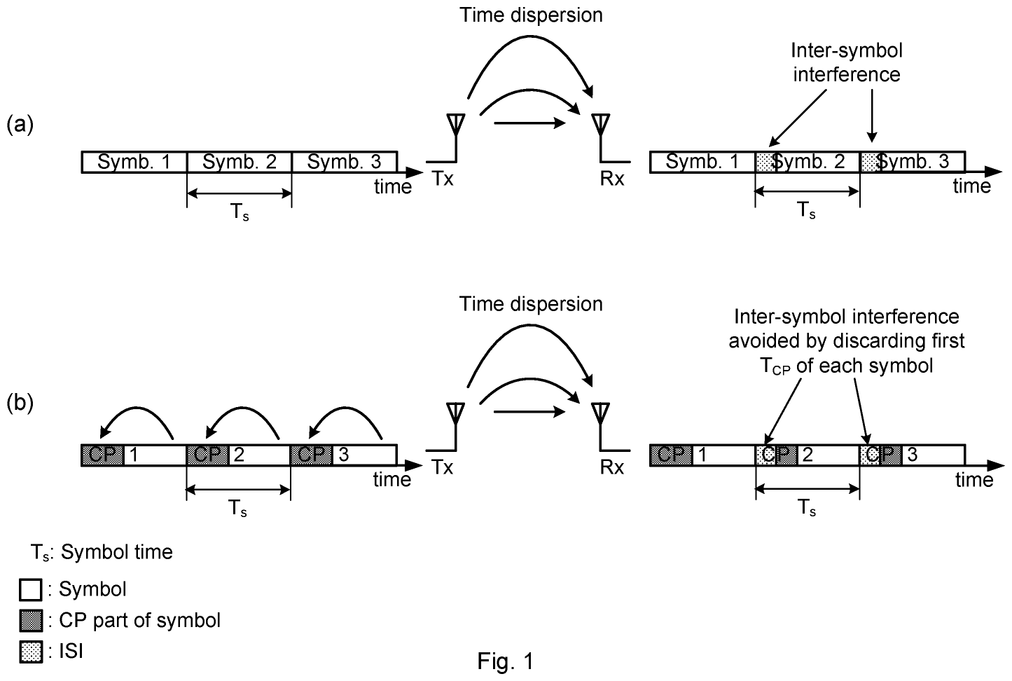

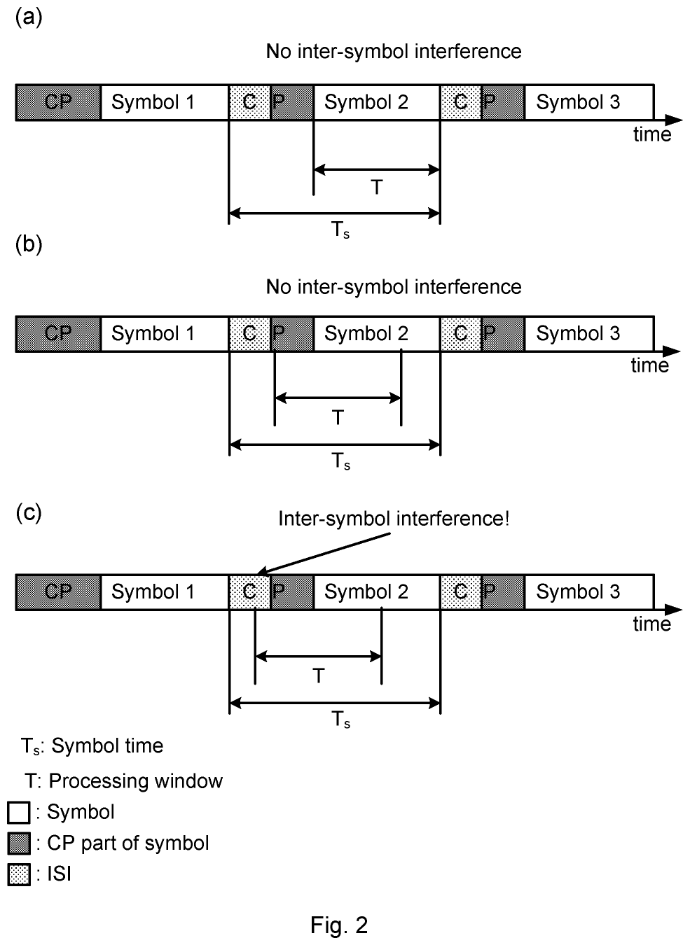

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

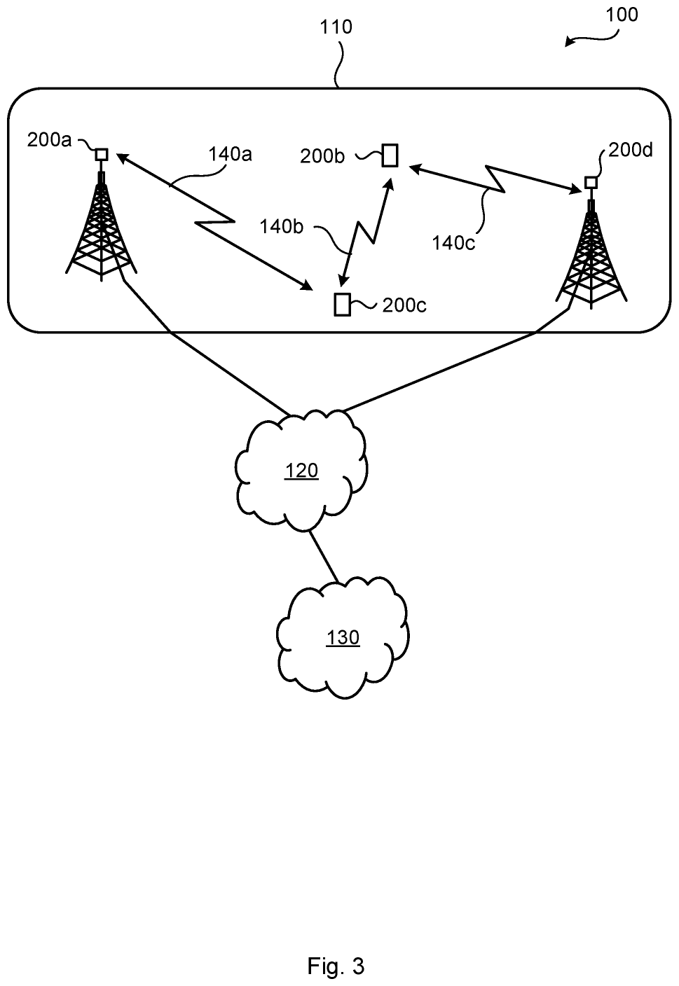

FIG. 3 is a schematic diagram illustrating a communication system 100 where embodiments presented herein can be applied. The communication system 100 could be a third generation (3G) telecommunication network, a fourth generation (4G) telecommunication network, or a fifth (5G) telecommunication network and support any 3GPP telecommunications standard.

The communication system 100 comprises wireless transceiver units 200a, 200b, 200c, 200d. In this respect, wireless transceiver units 200a, 200d are exemplified by access network nodes and wireless transceiver unit 200b, 200c are exemplified as user equipment (UE). Non-limiting examples of access network nodes are radio access network nodes, radio base stations, base transceiver stations, Node Bs (NBs), evolved Node Bs (eNBs), gNBs, access points, access nodes, and integrated access and backhaul nodes. Non-limiting examples of user equipment are wireless devices, mobile stations, mobile phones, handsets, wireless local loop phones, smartphones, laptop computers, tablet computers, network equipped sensors, network equipped vehicles, so-called Internet of Things devices, Virtual reality (VR) devices, Augmented reality (AR) devices, Extended reality (XR) devices, and network equipped gaming controllers. The access network nodes are configured to provide network access to the UE in an (radio) access network 110 over wireless links 140a, 140c. Further, one UE might also exchange information with another UE over a wireless link 140b. The access network 110 is operatively connected to a core network 120. The core network 120 is in turn operatively connected to a service network 130, such as the Internet, an Intranet, or a private industrial network. The connection from the core network 120 to the service network 130 may be optional in some scenarios, e.g., when the core network 120 is providing services directly, such as in some private industrial networks. The UE are thereby, via the at least one of the access network nodes, enabled to access services of, and exchange data with, the service network 130 or core network 120.

As noted above there could be cases where the strategy to position the start t₀ of the receiver symbol processing window such that the time-dispersive radio propagation channel is maximally contained in the time interval spanning from t₀ to t₀+T_{CP} does not lead to the best placement of the receiver symbol processing window. There is therefore still a need for techniques that enable improved placement of the receiver symbol processing window.

In this respect, as an illustrative example, with NR and LTE based communication systems the same radio signals are used for both positioning purposes and communication purposes. In some cases even the same reference signals are used for both positioning purposes and communication purposes, while in other cases specific reference signals for positioning are multiplexed into the radio signal.

Reference signal time difference (RSTD) measurements are mostly used for network-based positioning. For a UE to collect RSTD measurements, a location server in the network provides information of a search window in assistance data to the UE as described in 3GPP TS 37.355 “LTE Positioning Protocol (LPP)”, V16.4.0. The UE then searches for signals within this search window from different access network nodes. This search window reduces the search space for the UE to obtain the RSTD measurements. However, the use of the search window still does not prevent the UE from selecting incorrect peaks for computing the RSTD measurements, which could be the case if receiver symbol processing window has been incorrectly placed.

Further in this respect, when an OFDM signal is used for positioning purposes, the SNR is not the only metric deciding the performance. It has turned out that accurately detecting the first arriving multipath is very important for accurate range estimation. Hence, the above disclosed state of the art strategy to position the receiver symbol processing window to minimize the ISI and ICI might not be optimal, or even good, in the context of positioning purposes.

In essence, optimal placement of the receiver symbol processing window with respect to maximization of the signal to interference plus noise ratio (SINR) means maximizing the energy of the impulse response in the CP, whilst optimal placement of the receiver symbol processing window for positioning purposes means ensuring that any early tap is included—this means an earlier sample start for the receiver symbol processing window than for communication purposes.

An incorrect placement of the receiver symbol processing window could result in a channel impulse response that can provide misleading information for positioning purposes, such as detection of a line-of-sight (LOS) or non-line-of-sight (NLOS) situation of a link based on the power of first of path relative to other subsequent paths.

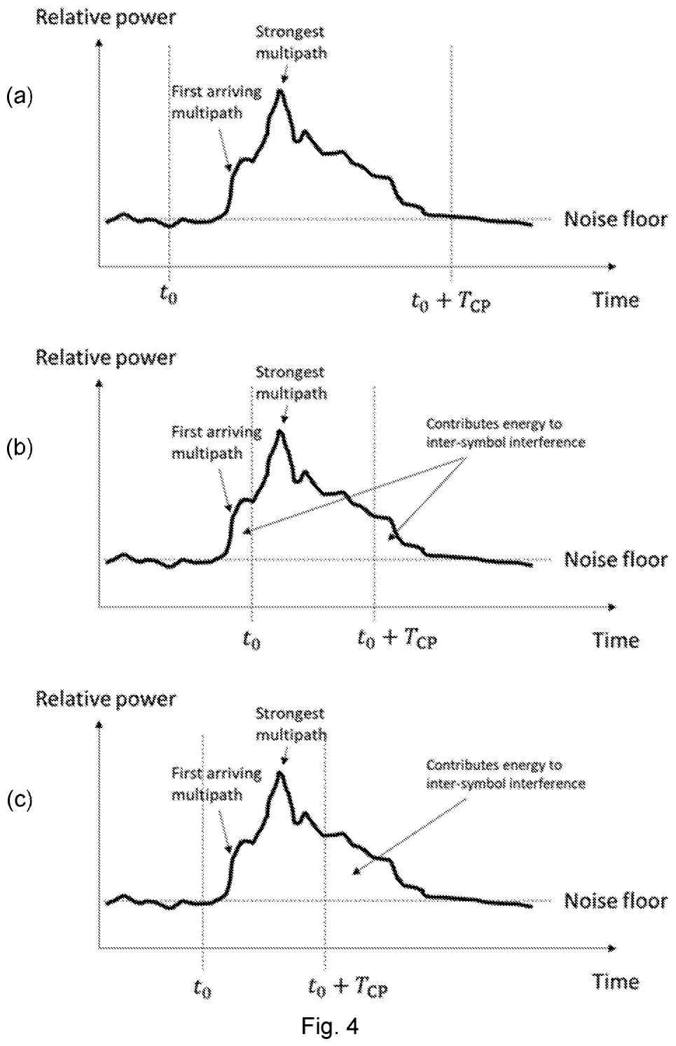

This is illustrated in FIG. 4. FIG. 4 schematically illustrates different channel impulse responses and receiver symbol processing windows. FIG. 4(a) illustrates an example of a channel impulse response that is short in relation to the CP. By placing the receiver symbol processing window suitably, all energy in the impulse response is contained within the receiver symbol processing window, leading to no ISI. FIG. 4(b) illustrates an example of a channel impulse response that is long in relation to the cyclic prefix. According to state of the art, the ISI can be minimized by maximizing the energy of the channel impulse response within the CP. FIG. 4(c) illustrates an example of a channel impulse response that is long in relation to the CP. The herein disclosed inventive concept has here been applied to shift the receiver symbol processing window so that the first arriving multipath is contained within the receiver symbol processing window. This is at the cost of an increased ISI compared to the state of the art. For some applications, such as positioning applications, however, the SNR or ISI may be less important than the correct detection of the first multipath.

The embodiments disclosed herein therefore relate to mechanisms for purpose-dependent determination of the start of a receiver symbol processing window. In order to obtain such mechanisms there is provided a wireless transceiver unit 200a, 200b, a method performed by the wireless transceiver unit 200a, 200b, a computer program product comprising code, for example in the form of a computer program, that when run on a wireless transceiver unit 200a, 200b, causes the wireless transceiver unit 200a, 200b to perform the method.

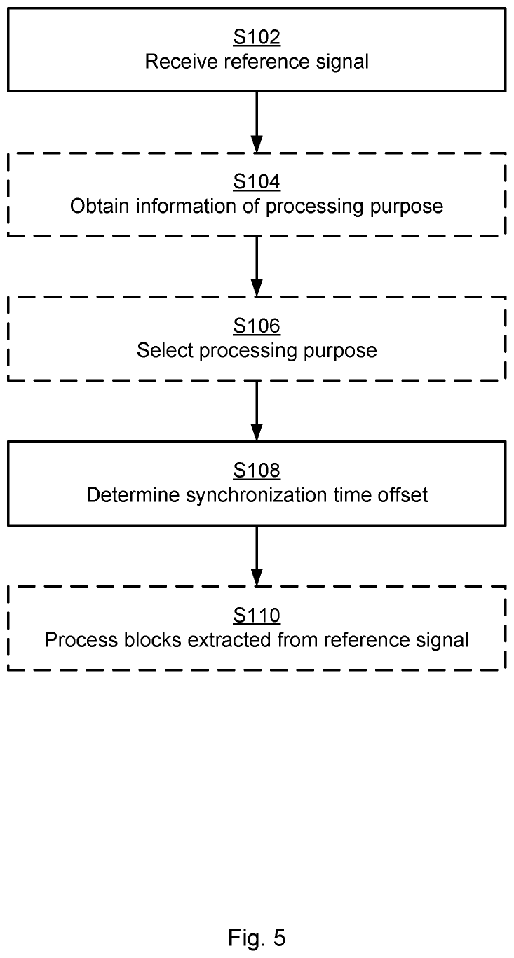

FIG. 5 is a flowchart illustrating embodiments of methods for purpose-dependent determination of the start of the receiver symbol processing window. The methods are performed by the wireless transceiver unit 200a, 200b. The methods are advantageously provided as computer programs 920.

S102: The wireless transceiver unit 200a, 200b receives, from another wireless transceiver unit 200c, 200d, a reference signal based on which the start of the receiver symbol processing window is to be determined. The receiver symbol processing window might define an FFT window.

The reference signal is to be processed for a processing purpose selected from a set of at least two different processing purposes. Examples of processing purposes will be disclosed below.

S108: The wireless transceiver unit 200a, 200b determines a synchronization time offset t₀ from measurements on the reference signal according to an estimation process that is a function of the processing purpose. The synchronization time offset t₀ defines placement of the start of the receiver symbol processing window. The estimation process might define, or encompass, an algorithm that is used to find the synchronization time offset to.

According to the estimation process, the start of the receiver symbol processing window is placed differently with respect to the at least two different processing purposes.

Embodiments relating to further details of purpose-dependent determination of the start of a receiver symbol processing window as performed by the wireless transceiver unit 200a, 200b will now be disclosed.

The method might be performed by any of a radio access network node 200a and a UE 200b. That is, the wireless transceiver unit 200a, 200b might be a radio access network node 200a or a UE 200b.

In some embodiments, the receiver symbol processing window has a length in time equal to the symbol time of the reference signal.

In some aspects, the wireless transceiver unit 200a, 200b actively selects the processing purpose. In particular, in some embodiments, the wireless transceiver unit 200a, 200b is configured to perform (optional) steps S104 and S106:

S104: The wireless transceiver unit 200a, 200b obtains information of for which of the at least two different processing purposes the reference signal is to be processed.

Step S104 might be performed either before or after step S102.

S106: The wireless transceiver unit 200a, 200b selects the processing purpose according to the information before determining the synchronization time offset t_o.

In this respect, as will be further disclosed below, at least two estimation processes might in parallel be applied to the same reference signal. In such a case, at least two occurrences of each of steps S104 and S106 might be performed in parallel; each one for selecting one respective processing purpose.

Aspects of the at least two different processing purposes will be disclosed next.

In some embodiments, one synchronization timing (i.e. placement of the receiver symbol processing window) are maintained for communication purposes, and one is maintained for positioning purposes. Particularly, in some embodiments, one of the at least two different processing purposes pertains to positioning of the wireless transceiver unit 200a, 200b. Particularly, in some embodiments, one of the at least two different processing purposes pertains to wireless communication between the wireless transceiver unit 200a, 200b and another wireless transceiver unit 200c, 200d. In some non-limiting examples, the communication purpose, and hence the wireless communication between the wireless transceiver unit 200a, 200b and another wireless transceiver unit 200c, 200d, pertains to a mobile broadband (MBB) service, or enhanced MBB (eMBB) service. This might involve decoding of data channels (such as a physical uplink shared channel (PUSCH) or a physical downlink shared channel PDSCH), and/or decoding of control channels (such as a physical uplink control channel (PUCCH) or a physical downlink control channel PDCCH), etc.

Aspects of the reference signal will be disclosed next.

In some aspects, the same reference signal is used regardless of the processing purpose. That is, in some embodiments, the reference signal is of a type that is independent from the processing purpose it is to be processed for. Non-limiting examples of such reference signals are: channel state information reference signal (CSI-RS), sounding reference signal (SRS), demodulation reference signal (DMRS).

In some aspects, the type of reference signal depends on the processing purpose. That is, in some embodiments, the reference signal is of a type that corresponds to the processing purpose it is to be processed for. For example, for positioning purposes, the reference signal might be positioning reference signal (PRS).

Aspects of placement of the receiver symbol processing window will be disclosed next.

In some aspects, the receiver symbol processing window is placed with an object to ensure that the first multipath is within the receiver symbol processing window. In particular, in some embodiments, the reference signal arrives along at least two multipaths, the estimation process involves estimating an impulse response for the reference signal, and, according to the estimation process, the start of the receiver symbol processing window is placed with an object to retain a tap of the impulse response corresponding to the time-wise first arriving multipath within the receiver symbol processing window. This could be the case where the processing purpose pertains to positioning of the wireless transceiver unit 200a, 200b. Hence, at least some of the herein disclosed embodiments are based on adopting a new strategy for the synchronization (or equivalently, for determining the start of the receiver symbol processing window) whereby the likelihood that the first multipath is contained within the receiver symbol processing window is increased.

In some aspects, the receiver symbol processing window is placed with an object to ensure maximum energy is within the receiver symbol processing window. In particular, in some embodiments, the estimation process involves estimating an impulse response for the reference signal, and, according to the estimation process, the start of the receiver symbol processing window is placed with an object to maximize signal energy of the impulse response within the receiver symbol processing window. This could be the case where the processing purpose pertains to wireless communication between the wireless transceiver unit 200a, 200b and another wireless transceiver unit 200c, 200d.

In some aspects, the receiver symbol processing window for positioning purposes is placed earlier than for communication purposes. Particularly, in some embodiments, according to the estimation process, the start of the receiver symbol processing window when the processing purpose pertains to positioning is placed earlier in time than when the processing purpose pertains to communication.

In some aspects, the start of the receiver symbol processing window for one processing purpose is a fixed offset from the start of the receiver symbol processing window for another processing purpose. Particularly, in some embodiments, according to the estimation process, the start of the receiver symbol processing window for one of the at least two different processing purposes is distanced a fixed offset in time from the start of the receiver symbol processing window for another one of the at least two different processing purposes.

In some aspects, the fixed offset is a certain fraction of the CP. That is, in some embodiments, the reference signal has a CP with a length T_{CP}, and the fixed offset corresponds to a fraction of the length of the CP. It is here also noted that T_{CP} could be different for different types of reference signals and hence this might impact the value of the delay factor δ. For example, when a PRS is used for time synchronization among access network nodes with known locations, the time synchronization can be tighter and the CP duration can be adjusted accordingly to enable the first or desired multipath to be captured within the receiver symbol processing window. Any prior information on time synchronization among the access network nodes could be used to set the CP timing boundaries. As multiple access network nodes transmitting during the same symbol duration may have different Channel Impulse Response (CIR) offset for a given UE. Without loss of generality, for the remainder of this disclosure it is assumed that T_{CP} is fixed.

In some aspects, the wireless transceiver unit 200a, 200b performs further processing on blocks extracted from the reference signal. In some examples, the processing comprises OFDM demodulation, including performing an FFT. In particular, the reference signal might have a CP with a time length T_{CP}, and, in some embodiments, the wireless transceiver unit 200a, 200b is configured to perform (optional) step S110:

S110: The wireless transceiver unit 200a, 200b processes blocks extracted from the reference signal according to the processing purpose, starting in time from the block at time t₀+T_{CP}+δ, where δ≥0 is a delay factor.

That is, not taking into account the delay factor δ, the processing starts after the CP, where the CP marks the start of the reference signal and the start of the CP is given by t₀, and where t₀ is the synchronization time offset determined in step S108. The delay factor δ is defined below.

In some aspects, at least two parallel processes are operating on the same time domain signal. That is, in some embodiments, at least two estimation processes are applied to the same reference signal, one for each of the at least two different processing purposes. In this respect, for the communication purpose, not only reference signals are processed, but also data and control information.

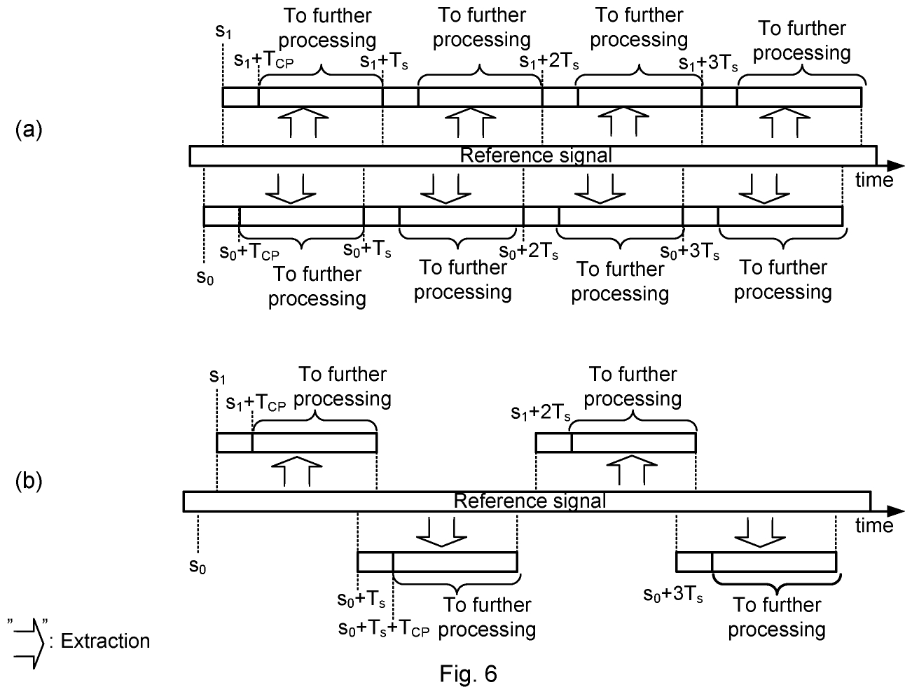

There could be different ways in which the at least two estimation processes are applied to the same reference signal. Reference is here made to FIG. 6. FIG. 6 schematically illustrates extraction of blocks from the reference signal for further processing for two different processing purposes; a communication purpose and a positioning purpose. The extraction is in FIG. 6 represented by an arrow. As an example, in FIG. 6(a) the first extraction starts at time s₀ and ends at time s₀+Tₛ, but only blocks from time s₀+T_{CP} to s₀+Tₛ are actually used for further processing. Thus, blocks from time s₀ to time s₀+Tₛ are extracted from the received reference signal, but only the blocks from time s₀+T_{CP} to time s₀+Tₛ are used for further processing for the positioning purpose. Likewise, in FIG. 6(b) the las extraction starts at time s₀+3Tₛ and ends at time s₀+4Tₛ, but only blocks from time s₀+3Tₛ+T_{CP} to s₀+4Tₛ are actually used for further processing. Thus, blocks from time s₀ to time s₀+3Tₛ are extracted from the received reference signal, but only the blocks from time s₀+3Tₛ+T_{CP} to time s₀+4Tₛ are used for further processing for the positioning purpose.

The value of the synchronization time offset t₀ is smaller for the processing purpose than for the communication purpose. That is, the receiver symbol processing window starts earlier for the processing purpose than for the communication purpose. In FIG. 6, t₀ is denoted s₀ for the positioning purpose and s₁ for the communication purpose. In FIG. 6(a) blocks are extracted from the reference signal starting in time from the block at time t₀+T_{CP} i.e., at time s₀+T_{CP} for the positioning purpose and at time s₁+T_{CP} for the communication purpose. In FIG. 6(b) blocks are extracted from the reference signal starting in time from the block at time t₀+T_{CP}+δ, i.e., at time s₀+T_{CP}+δ for the positioning purpose and at time s₁+T_{CP}+δ for the communication purpose, and where, as will be explained below, δ=Tₛ for the positioning purpose and δ=0 for the communication purpose.

In some aspects, each of the at least two estimation processes are applied to at least some of the same blocks of the reference signal. An example of this is illustrated in FIG. 6(a). Particularly, in some embodiments, at least some of the blocks are processed for both of the at least two different processing purposes upon the at least two estimation processes having been applied to time-wise overlap. A different value of the synchronization time offset t₀ is determined in step S108 for each of the at least two different processing purposes. The delay factor S introduced above is then δ=0 for both of the at least two different processing purposes for the start of the first occurring blocks to be further processed.

In some aspects, each of the at least two estimation processes are applied to its own subset of blocks. An example of this is illustrated in FIG. 6(b). Particularly, in some embodiments, respectively different blocks are processed for each of the at least two different processing purposes upon the at least two estimation processes having been applied to not time-wise overlap. A different value of the synchronization time offset to s determined in step S108 for each of the at least two different processing purposes. The delay factor δ introduced above is then δ=k·Tₛ, where k=0, 1, . . . , K−1 for processing purpose k+1 out of K total processing purposes, where Tₛ denotes symbol time of the reference signal.

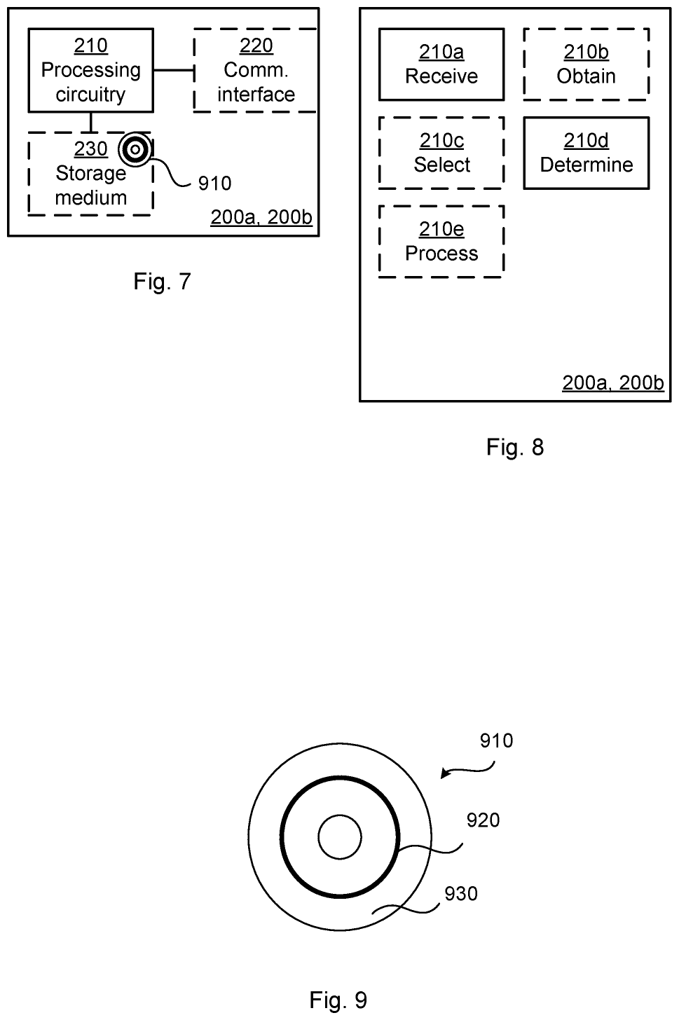

FIG. 7 schematically illustrates, in terms of a number of functional units, the components of a wireless transceiver unit 200a, 200b according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the wireless transceiver unit 200a, 200b to perform a set of operations, or steps, as disclosed above. For example, the storage medium 230 may store the set of operations, and the processing circuitry 210 may be configured to retrieve the set of operations from the storage medium 230 to cause the wireless transceiver unit 200a, 200b to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The wireless transceiver unit 200a, 200b may further comprise a communications interface 220 at least configured for communications with another wireless transceiver unit 200c, 200d. As such the communications interface 220 may comprise one or more transmitters and receivers, comprising analogue and digital components. The processing circuitry 210 controls the general operation of the wireless transceiver unit 200a, 200b e.g. by sending data and control signals to the communications interface 220 and the storage medium 230, by receiving data and reports from the communications interface 220, and by retrieving data and instructions from the storage medium 230. Other components, as well as the related functionality, of the wireless transceiver unit 200a, 200b are omitted in order not to obscure the concepts presented herein.

FIG. 8 schematically illustrates, in terms of a number of functional modules, the components of a wireless transceiver unit 200a, 200b according to an embodiment. The wireless transceiver unit 200a, 200b of FIG. 8 comprises a number of functional modules; a receive module 210a configured to perform step S102, and a determine module 210d configured to perform step S108. The wireless transceiver unit 200a, 200b of FIG. 8 may further comprise a number of optional functional modules, such as any of an obtain module 210b configured to perform step S104, a select module 210c configured to perform step S106, and a process module 210e configured to perform step S110. In general terms, each functional module 210a:210e may in one embodiment be implemented only in hardware and in another embodiment with the help of software, i.e., the latter embodiment having computer program instructions stored on the storage medium 230 which when run on the processing circuitry makes the wireless transceiver unit 200a, 200b perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210e may be implemented by the processing circuitry 210, possibly in cooperation with the communications interface 220 and/or the storage medium 230. The processing circuitry 210 may thus be configured to from the storage medium 230 fetch instructions as provided by a functional module 210a:210e and to execute these instructions, thereby performing any steps as disclosed herein.

The wireless transceiver unit 200a, 200b may be provided as a standalone device or as a part of at least one further device. For example, the wireless transceiver unit 200a, 200b may be provided in a access network node 200a or a UE 200b.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for purpose-dependent determination of start of a receiver symbol processing window, the method being performed by a wireless transceiver unit, the method comprising:
receiving, from another wireless transceiver unit, a reference signal based on which the start of the receiver symbol processing window is to be determined, wherein the reference signal is to be processed for a processing purpose selected from a set of at least two different processing purposes; and
determining a synchronization time offset t₀ from measurements on the reference signal according to an estimation process that is a function of the processing purpose,
wherein the synchronization time offset t₀ defines placement of the start of the receiver symbol processing window, and
wherein, according to the estimation process, the start of the receiver symbol processing window is placed differently with respect to the at least two different processing purposes.

2. The method according to claim 1, wherein the method further comprises:
obtaining information of for which of the at least two different processing purposes the reference signal is to be processed; and
selecting the processing purpose according to the information before determining the synchronization time offset t₀.

3. The method according to claim 1, wherein one of the at least two different processing purposes pertains to wireless communication between the wireless transceiver unit and said another wireless transceiver unit.

4. The method according to claim 1, wherein the estimation process involves estimating an impulse response for the reference signal, and wherein, according to the estimation process, the start of the receiver symbol processing window is placed with an object to maximize signal energy of the impulse response within the receiver symbol processing window.

5. The method according to claim 1, wherein one of the at least two different processing purposes pertains to positioning of the wireless transceiver unit.

6. The method according to claim 1, wherein the estimation process involves estimating an impulse response for the reference signal, wherein the reference signal arrives along at least two multipaths, and wherein, according to the estimation process, the start of the receiver symbol processing window is placed with an object to retain a tap of the impulse response corresponding to the time-wise first arriving multipath within the receiver symbol processing window.

7. The method according to claim 5, wherein
one of the at least two different processing purposes pertains to wireless communication between the wireless transceiver unit and said another wireless transceiver unit, and
according to the estimation process, the start of the receiver symbol processing window when the processing purpose pertains to positioning is placed earlier in time than when the processing purpose pertains to communication.

8. The method according to claim 1, wherein the reference signal is of a type that is independent from the processing purpose it is to be processed for or is of a type that corresponds to the processing purpose it is to be processed for.

9. (canceled)

10. The method according to claim 1, wherein, according to the estimation process, the start of the receiver symbol processing window for one of the at least two different processing purposes is distanced a fixed offset in time from the start of the receiver symbol processing window for another one of the at least two different processing purposes.

11. The method according to claim 10, wherein the reference signal has a cyclic prefix with a length, and wherein the fixed offset corresponds to a fraction of the length of the cyclic prefix.

12. The method according to claim 1, wherein the reference signal has a cyclic prefix with a time length T_{CP}, and wherein the method further comprises:
processing blocks extracted from the reference signal according to the processing purpose, starting in time from the block at time t₀+T_{CP}+δ, where δ≥0 is a delay factor.

13. The method according to claim 1, wherein at least two estimation processes are applied to the same reference signal, one for each of the at least two different processing purposes.

14. The method according to claim 12, wherein
at least two estimation processes are applied to the same reference signal, one for each of the at least two different processing purposes, and
at least some of the blocks are processed for both of the at least two different processing purposes upon the at least two estimation processes having been applied to time-wise overlap, wherein t₀ is different for each of the at least two different processing purposes, and wherein δ=0 for both of the at least two different processing purposes.

15. The method according to claim 12, wherein
at least two estimation processes are applied to the same reference signal, one for each of the at least two different processing purposes, and
respectively different blocks are processed for each of the at least two different processing purposes upon the at least two estimation processes having been applied to not time-wise overlap, wherein t₀ is different for each of the at least two different processing purposes, and wherein δ=k·Tₛ, where k=0, 1, . . . , K−1 for processing purpose k+1 out of K total processing purposes, and Tₛ denotes symbol time of the reference signal.

16. The method according to claim 1, wherein the receiver symbol processing window has a length in time equal to symbol time of the reference signal.

17. A wireless transceiver unit for purpose-dependent determination of start of a receiver symbol processing window, the wireless transceiver unit comprising processing circuitry, the processing circuitry being configured to cause the wireless transceiver unit to:
receive, from another wireless transceiver unit, a reference signal based on which the start of the receiver symbol processing window is to be determined, wherein the reference signal is to be processed for a processing purpose selected from a set of at least two different processing purposes; and
determine a synchronization time offset t₀ from measurements on the reference signal according to an estimation process that is a function of the processing purpose,
wherein the synchronization time offset t₀ defines placement of the start of the receiver symbol processing window, and
wherein, according to the estimation process, the start of the receiver symbol processing window is placed differently with respect to the at least two different processing purposes.

18. (canceled)

19. (canceled)

20. A non-transitory computer readable storage medium storing a computer program for purpose-dependent determination of start of a receiver symbol processing window, the computer program comprising computer code which, when run on processing circuitry of a wireless transceiver unit, causes the wireless transceiver unit to:
receive, from another wireless transceiver unit, a reference signal based on which the start of the receiver symbol processing window is to be determined, wherein the reference signal is to be processed for a processing purpose selected from a set of at least two different processing purposes; and
determine a synchronization time offset t₀ from measurements on the reference signal according to an estimation process that is a function of the processing purpose,
wherein the synchronization time offset t₀ defines placement of the start of the receiver symbol processing window, and
wherein, according to the estimation process, the start of the receiver symbol processing window is placed differently with respect to the at least two different processing purposes.

21. (canceled)

22. The wireless transceiver unit according to claim 17, wherein the processing circuitry is configured to cause the wireless transceiver unit to:
obtain information of for which of the at least two different processing purposes the reference signal is to be processed; and
select the processing purpose according to the information before determining the synchronization time offset t₀.

23. The wireless transceiver unit according to claim 17, wherein one of the at least two different processing purposes pertains to wireless communication between the wireless transceiver unit and said another wireless transceiver unit.

24. The wireless transceiver unit according to claim 17, wherein the estimation process involves estimating an impulse response for the reference signal, and wherein, according to the estimation process, the start of the receiver symbol processing window is placed with an object to maximize signal energy of the impulse response within the receiver symbol processing window.
